(19) United States
(12) Patent Application Publication
(10) Pub. No.: US 2013/0311966 A1
(43) Pub. Date: Nov. 21, 2013

(54) CIRCUIT DESIGN SUPPORT APPARATUS, COMPUTER-READABLE RECORDING MEDIUM, AND CIRCUIT DESIGN SUPPORT METHOD

(71) Applicant: FUJITSU LIMITED, Kawasaki-shi (JP)

(72) Inventor: Yumi FURUTA, Toyohashi (JP)

(73) Assignee: FUJITSU LIMITED, Kawasaki-shi (JP)

(21) Appl. No.: 13/948,222

(22) Filed: Jul. 23, 2013

Related U.S. Application Data
(63) Continuation of application No. PCT/JP2011/052167, filed on Feb. 2, 2011.

(51) Int. Cl. G06F 17/50

(52) U.S. Cl. CPC G06F 17/5009
USPC 716/136

(57) ABSTRACT

A circuit design support apparatus includes a simulating unit that simulates the operation of each circuit in a predetermined network on the basis of circuit information indicating the network, and generates simulated waveform information; a control unit that performs control so that simulated waveform information, which is information indicating a state of a signal of a terminal of each circuit in the network simulated by the simulating unit and is information for a period of time depending on the number of stages of sequential circuits in the circuit, is stored in a storage unit; and an output unit that outputs, when an error has been detected in a predetermined terminal, the simulated waveform information for the period of time stored in the storage unit to a waveform file for error analysis.

### CROSS-REFERENCE TO RELATED APPLICATION

This application is a continuation of International Application No. PCT/JP2011/052167, filed on Feb. 2, 2011, the entire contents of which are incorporated herein by reference.

### FIELD

The embodiment discussed herein is directed to a circuit design support apparatus, a computer-readable recording medium, and a circuit design support method.

### BACKGROUND

The circuit scale of integrated circuits, such as large scale integration (LSI), has been increasing in recent years. With this, it takes longer time to carry out one operation check test for checking the operation of an integrated circuit through simulation. Especially, when carrying out simulation of the operation of an integrated circuit on a gate level, it takes a lot of time to carry out an operation check test. Therefore, the time for an entire design flow process of designing an integrated circuit has also been getting longer in recent years.

Here, an example of a conventional design flow process is explained with reference to FIG. 16. FIG. 16 is a flowchart for explaining the example of the conventional design flow process. In the design flow process illustrated in FIG. 16, first, a designer designs specifications of an integrated circuit (Step S1). Then, the designer makes a logic design of the integrated circuit by using a predetermined tool (Step S2), and performs logic synthesis (Step S3). For example, in the logic design, the designer describes logic of the integrated circuit based on the specifications of the integrated circuit by using a description language such as register transfer level (RTL). In the logic synthesis, the designer selects elements used in the integrated circuit and synthesizes logics described in RTL or the like by using a tool for performing logic synthesis, thereby generating a netlist that describes the integrated circuit on a gate (element) level. Incidentally, when there is any circuit designed directly on a gate level without using a description language such as RTL, as for the circuit designed on the gate level, the process of logic synthesis (Step S3) can be omitted. Furthermore, when a logic design is by using a high-level description language such as RTL, logic verification using RTL or the like is performed; however, description of the logic verification is omitted in the flow illustrated in FIG. 16.

Next, the designer or a person involved inputs a test pattern including a predetermined input value and an expected output value corresponding to the input value to a computer that performs operation verification (operation test), and causes the computer to verify the operation of the logically-synthesized integrated circuit at the time of logic design (Step S4). Then, the designer or the person involved causes the computer to make a layout design of the integrated circuit, such as placement and wiring, on the basis of the netlist generated by the logic synthesis or the like (Step S5). And then, the designer or the person involved causes the computer to extract delay information of elements and wires of the integrated circuit after the layout design (Step S6). And then, the designer or the person involved causes the computer to perform the following process to determine whether timing violation arises or not. That is, the designer or the person involved inputs the delay information and layout design data, which is information on the integrated circuit which has been laid out, etc. to the computer, and causes the computer to perform static timing verification of the integrated circuit of which the layout has been designed (Step S7). When a timing error has been found in the static timing verification (Step S7), usually, processes of layout modification, extraction of delay information, and static timing verification are repeated until there is no timing error; however, description of this is omitted in the flow illustrated in FIG. 16.

Next, the designer or the person involved causes a simulator to perform the following process to do a dynamic operation check on a gate level. That is, the designer or the person involved inputs the layout design data, the test pattern used at Step S4, and the delay information, etc. to the simulator, and causes the simulator to perform an operation check test of the integrated circuit indicated by the layout design data (Step S8). The operation check test here means a function test for verifying the function of the integrated circuit or a scan test for verifying whether malfunction of any circuit element is found in shipping inspection to be described later, etc. In this operation check test, when there is an abnormality in the operation of the integrated circuit, a value output from an external output terminal does not match an expected output value, and this is detected as an error. Therefore, by determining whether an error has been detected or not by the operation check test, whether the integrated circuit after the layout design operates in accordance with the specifications can be confirmed.

Then, in the operation check test, the computer determines whether there is no error detected (Step S9). When no error has been detected by the computer (YES at Step S9), integrated circuits based on the layout design data are manufactured by various apparatuses for manufacturing integrated circuits in a factory or the like where integrated circuits are manufactured (Step S10). Then, an examiner or a person involved performs shipping inspection of the manufactured integrated circuits by using a predetermined test pattern (Step S11). When no error has been detected in the shipping inspection, the manufactured integrated circuits are shipped (Step S12).

On the other hand, when an error has been detected by the operation check test (NO at Step S9), the designer or the person involved performs an analysis for identifying a cause of the error (Step S13). As an example of the analysis, there is a method to identify a cause of the error in such a manner that the designer or the person involved checks a state of signal propagation of the integrated circuit by using a waveform display tool for displaying content of a waveform file to which a state of signal propagation of the integrated circuit is output, thereby checking the operation of the integrated circuit. As an example of the cause of the error, when there is a problem in the layout design data, for example, a timing error may still remain. Furthermore, as another example of the cause of the error, there may be a problem in the test pattern.

When there is a problem in the layout design data, the designer or the person involved modifies the layout (Step S14). Then, return to Step S6, the designer or the person involved causes the computer to extract delay information of elements and wires of the integrated circuit after the modified layout design.

On the other hand, when there is a problem in the test pattern, the designer or the person involved modifies the test pattern (Step S15). Then, return to Step S8, the designer or the person involved inputs the modified test pattern, the layout design data, and the delay information, etc. to the simulator, and causes the simulator to perform an operation check test of the integrated circuit indicated by the layout design data.

Generally, information of a signal output from an external output terminal of the integrated circuit indicated by the layout design data and information input to an external input terminal are output to the waveform file.

Furthermore, when the designer or the person involved has modified the layout (Step S14) or the test pattern (Step S15) and causes the simulator to do the operation check again (Step S8), information on a signal output from the external output terminal is again output to the waveform file.

An example of a procedure of the above-described error analysis is explained. In the error analysis, an analysis of the integrated circuit is performed on the basis of signal information output to the waveform file. The designer identifies a cause of the error by repeatedly performing the addition of a terminal whose information is to be output to the waveform file and an operation check test.

The error analysis procedure is explained with a concrete example. FIG. 17 is a diagram for explaining an example of the error analysis procedure. In the example illustrated in FIG. 17, cells A to H and an external output terminal Pₖ are contained in part of a circuit indicated by layout design data. In the example illustrated in FIG. 17, it is assumed that an output value X of the external output terminal Pₖ was different from a preset expected value X′ of the external output terminal Pₖ in an operation check test. In this case, an error is detected in the operation check test because the output value X was different from the expected value X′. Therefore, a designer checks contents of the waveform file. For example, to identify a cause for which the output value of the external output terminal Pₖ is “X”, the designer performs the following operation. That is, the designer first adds, as a terminal whose information is to be output to the waveform file, input terminals B1 to B3 of the cell B backward from an input terminal A of the cell A of which the output terminal EB is connected to the external output terminal Pₖ. Then, the designer performs an operation check test again. Consequently, respective states of signal propagation of the input terminals B1 to B3 of the cell B are newly output to the waveform file.

Then, the designer checks the states of signal propagation of the input terminals B1 to B3 of the cell B output to the waveform file, and identifies which terminal whose signal is a cause for which the output value of the external output terminal Pₖ is “X” out of the input terminals B1 to B3 of the cell B. For example, when expected values of the input terminals B1 to B3 of the cell B in normal operation have been set in advance, a causal input terminal can be identified by comparing signals of the input terminals B1 to B3 of the cell B with the expected values, respectively. Then, the designer performs the same process on a cell of which the output terminal is connected to the identified input terminal backward from the identified input terminal, and identifies a cell or external input terminal being a cause for which the output value of the external output terminal Pₖ is “X”.

For example, in the example illustrated in FIG. 17, a signal of the input terminal B1 of the cell B is assumed to be a cause for which the output value of the external output terminal Pₖ is “X”. In this case, which terminal whose signal is a cause for which the output value of the external output terminal Pₖ is “X” out of input terminals C1 to C4 of the cell C of which the output terminal C5 is connected to the input terminal B1 is identified. For example, the designer first adds the input terminals C1 to C4 of the cell C as a terminal whose information is to be output to the waveform file. Then, the designer performs an operation check test again. Consequently, respective states of signal propagation of the input terminals C1 to C4 of the cell C are newly output to the waveform file. Then, the designer identifies a causal input terminal by comparing signals of the input terminals C1 to C4 of the cell C with expected values of the input terminals C1 to C4 of the cell C in normal operation, respectively.

In the example illustrated in FIG. 17, a signal of the input terminal C2 of the cell C is assumed to be a cause for which the output value of the external output terminal Pₖ is “X”. In this case, which terminal whose signal is a cause for which the output value of the external output terminal Pₖ is “X” out of input terminals E1 and E2 of the cell E of which the output terminal E3 is connected to the input terminal C2 is identified. For example, the designer first adds the input terminals E1 and E2 of the cell E as a terminal whose information is to be output to the waveform file. Then, the designer performs an operation check test again. Consequently, respective states of signal propagation of the input terminals E1 and E2 of the cell E are newly output to the waveform file. Then, the designer identifies a causal input terminal by comparing signals of the input terminals E1 and E2 of the cell E with expected values of the input terminals E1 and E2 of the cell E in normal operation, respectively.

The designer repeatedly performs this process, and identifies a cell or external input terminal being a cause for which the output value of the external output terminal Pₖ is “X”. Then, the designer analyzes a signal state input from the identified cell or external input terminal, which is signal states before and after the output value of the external output terminal Pₖ has become “X”, and analyzes why the output value of the external output terminal Pₖ is “X”. Then, when a result of the analysis indicates that there is a problem in the layout design data, the designer modifies the layout design data. Furthermore, when a result of the analysis indicates that there is a problem in the test pattern, the designer modifies the test pattern and again performs an operation check test.

In this manner, information on a signal output from an external output terminal is first output to the waveform file, and after that, information on a signal input from an added terminal is output to the waveform file. However, in the way to output information to the waveform file, the number of operation check tests performed in the above-described error analysis is increased. This is because instead of outputting information on signals input from terminals of all cells or terminals of a cell being a cause of an error to the waveform file from the beginning, terminals of a cell deemed to be a cause of an error from a result of an operation check test are added and then information on signals input from the added terminals is output to the waveform file.

Accordingly, to curb the number of operation check tests, there is a method of outputting information on signals of all terminals in a circuit to a waveform file during a period of an operation check test. Hereinafter, this method is referred to as a first method. In the first method, information on signals of all terminals during a period of an operation check test can be checked by viewing the waveform file; therefore, performing one operation check test is carried out. FIG. 18 is a diagram illustrating an amount of information output to the waveform file by the first method. The horizontal axis in FIG. 18 indicates the time from the start of an operation check test to the end of the operation check test, and the vertical axis indicates the number of terminals whose signal information is to be output to the waveform file. As illustrated in FIG. 18, in the first method, an amount of information 90 output to the waveform file is proportional to the product of the number of all terminals and a period of the operation check test.

Furthermore, to curb the number of operation check tests, there is a method of outputting information on signals of terminals in a circuit within a range set by a designer in advance out of all terminals in the circuit to a waveform file during a period of an operation check test. Hereinafter, this method is referred to as a second method. In the second method, the designer estimates a circuit range in which an error may occur in advance, and sets the circuit so as to output signal information of terminals in the estimated circuit range to the waveform file. Consequently, in the second method, when an error has occurred in the circuit range estimated by the designer, performing one operation check test is carried out. FIG. 19 is a diagram illustrating an amount of information output to the waveform file by the second method. The horizontal axis in FIG. 19 indicates the time from the start of an operation check test to the end of the operation check test, and the vertical axis indicates the number of terminals whose signal information is to be output to the waveform file. As illustrated in FIG. 19, in the second method, an amount of information 91 output to the waveform file is proportional to the product of the number of terminals in the circuit within the range set by the designer in advance and a period of the operation check test. Therefore, when this range is narrower than the entire range of the circuit, an amount of information output to the waveform file is smaller than that is in the first method as illustrated in FIG. 19.

Moreover, to curb the number of operation check tests, there is a method of outputting information on signals of all terminals in a circuit to a waveform file at a predetermined time interval during a period of an operation check test. Hereinafter, this method is referred to as a third method. In the third method, a designer sets a time interval to output signal information to the waveform file in advance, and sets the circuit so as to output signal information of all terminals in the circuit to the waveform file at the preset time interval. FIG. 20 is a diagram illustrating an amount of information output to the waveform file by the third method. The horizontal axis in FIG. 20 indicates the time from the start of an operation check test to the end of the operation check test, and the vertical axis indicates the number of terminals whose signal information is to be output to the waveform file. As illustrated in FIG. 20, in the third method, the shorter the predetermined time interval is, the more frequently the signal information is output to the waveform file; therefore, an amount of information 92 output to the waveform file is proportional to the product of the reciprocal of the predetermined time interval and the number of all terminals. Therefore, in the third method, the time interval is set so that an amount of information output to the waveform file is smaller than that is in the first method, and, when an error has been detected at the timing to output signal information to the waveform file, the following effect can be obtained. That is, the third method can detect an error on the basis of a smaller amount of information output to the waveform file than that is in the first method.

Furthermore, to curb the number of operation check tests, there is known a technology of including input information which causes output of each element in content of information output from the element and outputting information output from an external output terminal to a waveform file. As a concrete example, in this technology, with respect to each element, information of an output event and information of an input event that causes the output event are output. Then, information output from the external output terminal, which is the final output, is output to the waveform file, and an examiner checks contents of the waveform file.

Patent document 1: Japanese Laid-open Patent Publication No. 2001-5841

However, the above-described methods and technology have a problem that an amount of information output to the waveform file is not suppressed while curbing the number of operation check tests.

The above-described problem is explained. In the above-described first method, signal information of all terminals in a circuit is output to the waveform file during a period of an operation check test; therefore, an amount of information output to the waveform file is larger than those in the other second and third methods.

Furthermore, in the above-described second method, an amount of information output to the waveform file is smaller than that is in the first method; however, when an error has occurred in another circuit out of the circuit range set by the designer in advance, changing the circuit range and performing an operation check test are carried out again. FIG. 21 is a diagram for explaining a case where an error has occurred in another circuit out of the circuit range set by the designer in advance in the second method. FIG. 21 illustrates an example where out of partial circuits 93 and 94 in an integrated circuit 96 indicated by layout design data, the partial circuit 93 is set so that signal information of terminals within a range of the partial circuit 93 is output to the waveform file; however, an error has occurred in an element 95 in the partial circuit 94. In this case, the circuit range of output to the waveform file is reset and performing an operation check test is carried out again. At this time, the circuit range has to be reset so as to include the element 95 where the error has occurred; however, the designer does not identify which point the error has occurred, and therefore, repeatedly performing an operation check test is carried out until the causal point can be identified.

Moreover, in the above-described third method, an amount of information output to the waveform file is smaller than that is in the first method; however, when an error has occurred at timing other than the time interval to output information to the waveform file, which has been set by the designer in advance, a point where the error has occurred is not identified. Therefore, in this case, repeatedly performing an operation check test by changing the time interval is carried out until a causal point of the occurrence of the error can be identified.

Furthermore, in the above-described technology, with respect to each element, information of an output event and information of an input event that causes the output event are output; therefore, an amount of information is enormous, and it takes time to analyze the information, and thus the technology is not practical.

### SUMMARY

According to an aspect of an embodiment, a circuit design support apparatus includes a simulating unit that simulates the operation of each circuit in a predetermined network on the basis of circuit information indicating the network, and generates simulated waveform information; a control unit that performs control so that simulated waveform information, which is information indicating a state of a signal of a terminal of each circuit in the network simulated by the simulating unit and is information for a period of time depending on the number of stages of sequential circuits in the circuit, is stored in a storage unit; and an output unit that outputs, when an error has been detected in a predetermined terminal, the simulated waveform information for the period of time stored in the storage unit to a waveform file for error analysis.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a circuit design support apparatus according to a embodiment;

FIG. 2 illustrates an example of a network indicated by logic circuit information;

FIG. 3 illustrates an example of a delay time indicated by circuit delay information;

FIG. 4 illustrates an example of a network indicated by logic circuit information;

FIG. 5 illustrates an example of a network indicated by logic circuit information;

FIG. 6 is a diagram illustrating an example of temporary data according to the embodiment;

FIG. 7 is a diagram illustrating an example of temporary data after the elapse of a predetermined time since the point of time illustrated in FIG. 6;

FIG. 8 is a diagram for explaining an example of a storage method of a storage control unit according to the embodiment;

FIG. 9 is a diagram for explaining a terminal whose information is to be output to a waveform file;

FIG. 10 is a diagram for explaining a process of extracting information to be output to the waveform file from temporary data;

FIG. 11 is a diagram for explaining the process of extracting information to be output to the waveform file from temporary data;

FIG. 12 is a flowchart illustrating a procedure of a circuit design support process according to the embodiment;

FIG. 13 is a flowchart illustrating the procedure of the circuit design support process according to the embodiment;

FIG. 14 is a flowchart illustrating a procedure of a temporary-data storing process according to the embodiment;

FIG. 15 is a diagram illustrating a computer that executes a circuit design support program;

FIG. 16 is a flowchart for explaining an example of a conventional design flow process;

FIG. 17 is a diagram for explaining an example of an error analysis procedure;

FIG. 18 is a diagram illustrating an amount of information output to a waveform file by a first method;

FIG. 19 is a diagram illustrating an amount of information output to the waveform file by a second method;

FIG. 20 is a diagram illustrating an amount of information output to the waveform file by a third method; and

FIG. 21 is a diagram for explaining a case where an error has occurred in another circuit out of a circuit range set by a designer in advance in the second method.

### DESCRIPTION OF EMBODIMENTS

Preferred embodiments of the present invention will be explained with reference to accompanying drawings. Incidentally, the present invention is not limited to the embodiments.

### [a] Embodiment

### Configuration of Circuit Design Support Apparatus

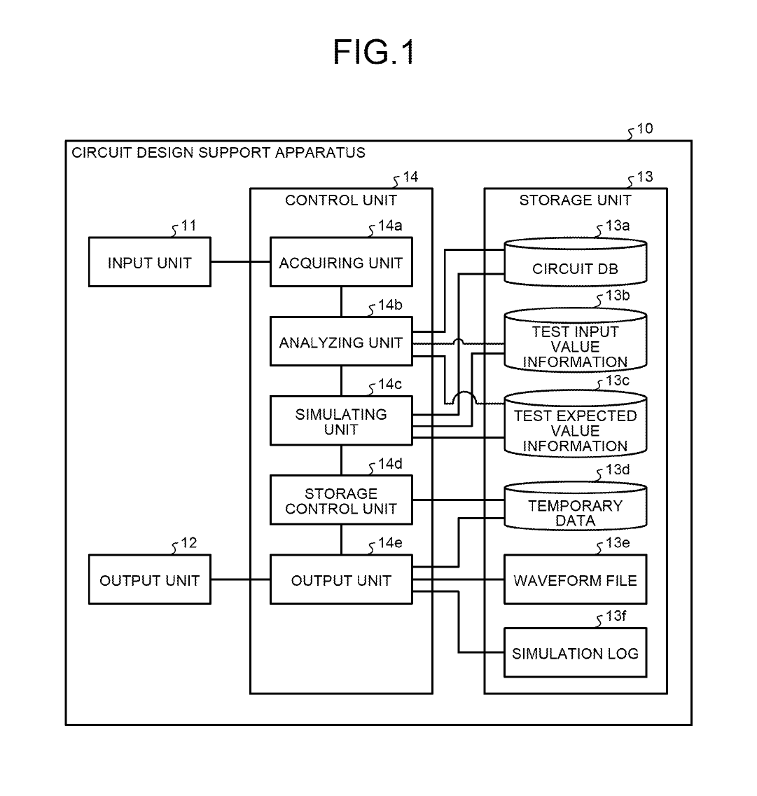

FIG. 1 is a diagram illustrating a configuration of a circuit design support apparatus according to a embodiment. A circuit design support apparatus 10 according to the present embodiment simulates the operation of a circuit in a predetermined network on the basis of circuit information indicating the network. Then, the circuit design support apparatus 10 according to the present embodiment outputs minimum information used for error analysis out of pieces of information indicating respective states of signals of terminals of the simulated circuit to a waveform file for error analysis.

As illustrated in FIG. 1, the circuit design support apparatus 10 includes an input unit 11, an output unit 12, a storage unit 13, and a control unit 14.

The input unit 11 inputs various kinds of information to the control unit 14. For example, upon acceptance of an instruction from a user, the input unit 11 acquires information from an external device via communication in accordance with the accepted instruction, and inputs the acquired information to the control unit 14. The input unit 11 can be an operation accepting device, such as a mouse and a keyboard. To explain with a concrete example, the input unit 11 inputs logic circuit information, which is information indicating a network subject to an operation test, to the control unit 14.

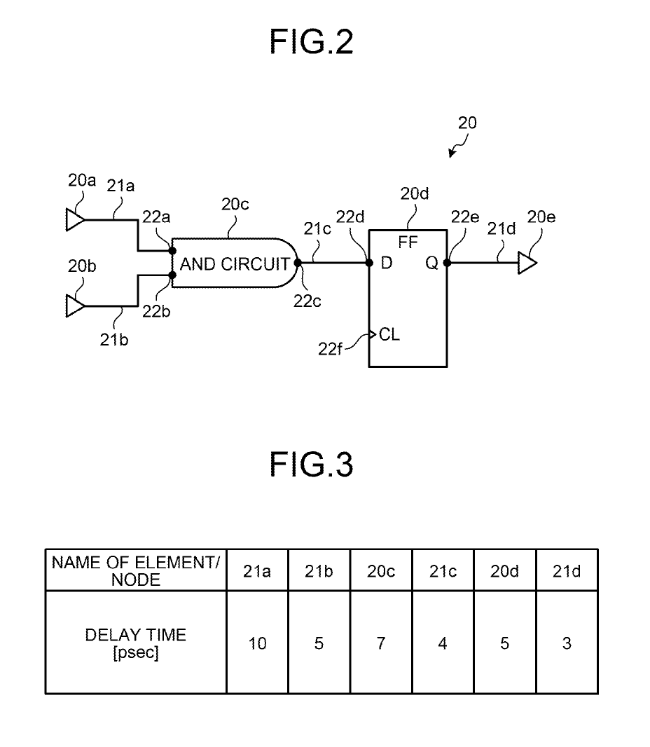

FIG. 2 illustrates an example of a network indicated by logic circuit information. In the example illustrated in FIG. 2, a network 20 includes external input terminals 20a and 20b, an AND circuit 20c, a flip-flop 20d, and an external output terminal 20e. In the example illustrated in FIG. 2, the AND circuit 20c includes input terminals 22a and 22b and an output terminal 22c. In the example illustrated in FIG. 2, the flip-flop 20d, which is a sequential circuit, includes a data input terminal 22d, a data output terminal 22e, and a clock input terminal 22f. In the example illustrated in FIG. 2, the network 20 further includes a wire 21a connecting the external input terminal 20a to the input terminal 22a and a wire 21b connecting the external input terminal 20b to the input terminal 22b. Furthermore, in the example illustrated in FIG. 2, the network 20 further includes a wire 21c connecting the output terminal 22c to the data input terminal 22d and a wire 21d connecting the data output terminal 22e to the external output terminal 20e. Incidentally, in the description below, the “flip-flop” is abbreviated to the “FF”.

Furthermore, the input unit 11 inputs circuit delay information, which is information indicating a delay time of information transmission from an input terminal to an output terminal between circuits in the network indicated by the logic circuit information and a delay time of a wire connecting between the circuits, to the control unit 14. The delay time of a wire connecting between circuits here means, for example, a delay time of information transmission from an output terminal of a circuit to an input terminal of another circuit connected to the circuit via a wire.

FIG. 3 illustrates an example of the delay time indicated by the circuit delay information. In the example illustrated in FIG. 3, it is indicated that a delay time of the wire 21a is 10 [psec]. Furthermore, in the example illustrated in FIG. 3, it is indicated that a delay time of the wire 21b is 5 [psec]. Moreover, in the example illustrated in FIG. 3, it is indicated that a delay time of the AND circuit 20c is 7 [psec]. Furthermore, in the example illustrated in FIG. 3, it is indicated that a delay time of the wire 21c is 4 [psec]. Moreover, in the example illustrated in FIG. 3, it is indicated that a delay time of the FF 20d is 5 [psec]. Furthermore, in the example illustrated in FIG. 3, it is indicated that a delay time of the wire 21d is 3 [psec].

Moreover, the input unit 11 inputs a test pattern to the control unit 14. The test pattern here is information used in an operation check test. For example, the test pattern includes information defining the period and timing of a test clock used as the basis for circuit operation in the operation check test and a name of the test clock. Furthermore, the test pattern includes information defining a name of an external input terminal that externally changes the operation of a network subject to the operation check test, a pattern of a signal input to the external input terminal, and the timing to input the pattern to the external input terminal. Moreover, the test pattern includes information defining a name of an external output terminal that outputs information processed by a circuit in the network subject to the operation check test and an expected value which is a value expected to be output from the external output terminal when the pattern has been input to the external input terminal. Furthermore, the test pattern includes information defining the timing to determine whether a value of a signal output from the external output terminal is different from the expected value.

Furthermore, the input unit 11 inputs simulation options to the control unit 14. The simulation options here are conditions for execution of simulation in an operation check test. For example, the simulation options are set by an examiner who performs the operation check test or a person involved. The simulation options include the location of a library for simulation and various execution conditions.

Moreover, the input unit 11 inputs temporary data constraints to the control unit 14. The temporary data constraints here are information defining temporary data 13d to be described later. For example, the temporary data constraints include information defining a circuit range that information on a state of a signal of a terminal therein is to be stored as the temporary data 13d. This circuit range is set by identifying a logical hierarchy or identifying an element name of a sequential circuit. Furthermore, the temporary data constraints include information defining a duration of the temporary data 13d to be described later. Incidentally, the circuit range is selected by the examiner through use of a circuit viewer. Furthermore, the duration is represented by information of how many test-clock periods or a specific numerical value such as 100 μs.

The output unit 12 outputs various kinds of information. For example, the output unit 12 displays a result of simulation in an operation check test to be described later or a state of a signal of a terminal output to a waveform file 13e on a display device. Incidentally, the output unit 12 can be configured to output a result of simulation or a state of a signal of a terminal by voice output. Device examples of the output unit 12 include a display devices, such as a liquid crystal display (LCD) and a cathode ray tube (CRT), and a voice-output device that outputs a voice message.

The storage unit 13 stores therein various kinds of information. For example, the storage unit 13 stores therein various programs to be executed by the control unit 14. Furthermore, the storage unit 13 stores therein a circuit database 13a. Various kinds of information used for simulation in an operation check test are registered in the circuit database 13a. For example, logic circuit information and circuit delay information corresponding to the logic circuit information are registered in a record of the circuit database 13a by an analyzing unit 14b to be described later. Incidentally, in the description below, the “circuit database” is abbreviated to the “circuit DB”.

Moreover, the storage unit 13 stores therein the test input value information 13b. The test input value information 13b includes information on a test pattern of a signal input to an external input terminal in the network at the time of simulation in an operation check test. For example, as the test input value information 13b, the following information is stored in the storage unit 13 by the analyzing unit 14b. That is, information including a name of an external input terminal that externally changes the operation, a pattern of a signal input to the external input terminal, and the timing to input the pattern to the external input terminal, which have been obtained as a result of analysis of the test pattern by the analyzing unit 14b, is stored in the storage unit 13.

Furthermore, the storage unit 13 stores therein test expected value information 13c. The test expected value information 13c includes a value of a signal expected to be output from an external output terminal in the network at the time of simulation in an operation check test. For example, the test expected value information 13c includes a name of an external output terminal that outputs information processed by a circuit in the network subject to the operation check test, which has been obtained as a result of analysis of a test pattern by the analyzing unit 14b. Furthermore, the test expected value information 13c includes an expected value of a signal output from an external output terminal when a pattern obtained as a result of the analysis of the test pattern by the analyzing unit 14b has been input to an external input terminal.

Moreover, the storage unit 13 stores therein the temporary data 13d. The temporary data 13d is the minimum amount of information for error analysis which is needed to identify a circuit in which an error has occurred by one operation check test. For example, as the temporary data 13d, minimum information capable of identifying an element in which an error detected by the simulation has occurred is stored in the storage unit 13 by a storage control unit 14d to be described later. Incidentally, details of the temporary data 13d will be described later.

Furthermore, the storage unit 13 stores therein the waveform file 13e. The waveform file 13e is a file for error analysis. For example, when an error has been detected by the simulation, information related to the error out of the temporary data 13d is input to the waveform file 13e by an output unit 14e to be described later. Consequently, the examiner just has to analyze contents of the waveform file 13e which is the minimum amount of information used for error analysis, so that the error analysis can be easily performed by one operation check test.

Moreover, the storage unit 13 stores therein a simulation log 13f. The simulation log 13f is a log indicating a result of simulation or the like. For example, the simulation log 13f includes the time of an error which occurred in simulation, etc.

The storage unit 13 is, for example, a semiconductor memory device such as a random access memory (RAM) or a storage device such as a hard disk or an optical disk. Incidentally, the storage unit 13 is not limited to the above-described types of storage devices, and can be a semiconductor memory device such as a flash memory.

The control unit 14 is, for example, an electronic circuit such as a central processing unit (CPU) or a micro processing unit (MPU). The control unit 14 includes an internal memory for storing therein programs prescribing various processing procedures and control data, and executes various processes by using these. As illustrated in FIG. 1, the control unit 14 includes an acquiring unit 14a, the analyzing unit 14b, a simulating unit 14c, the storage control unit 14d, and the output unit 14e.

The acquiring unit 14a acquires various kinds of information. For example, the acquiring unit 14a acquires logic circuit information input from the input unit 11. Furthermore, the acquiring unit 14a acquires circuit delay information input from the input unit 11. Moreover, the acquiring unit 14a acquires a test pattern input from the input unit 11. Furthermore, the acquiring unit 14a acquires simulation options input from the input unit 11. Moreover, the acquiring unit 14a acquires temporary data constraints input from the input unit 11.

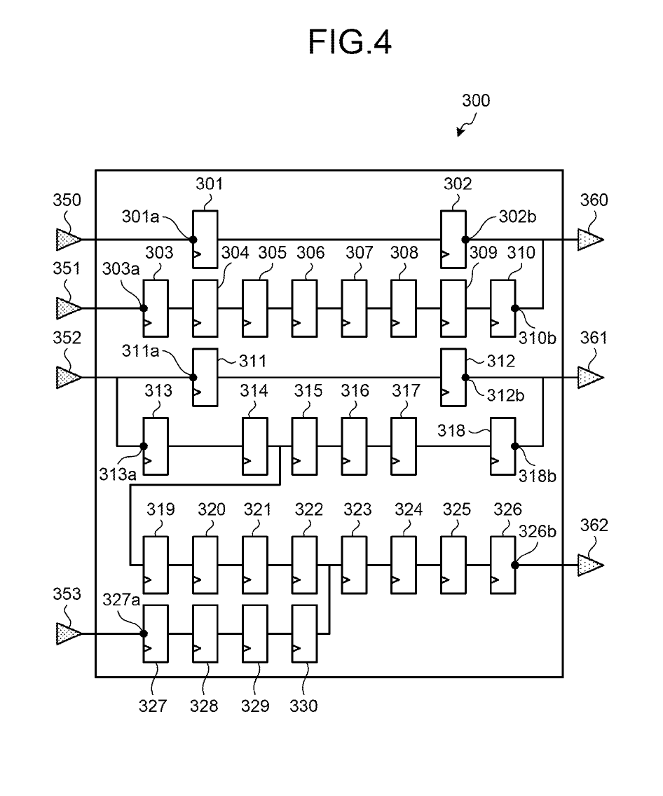

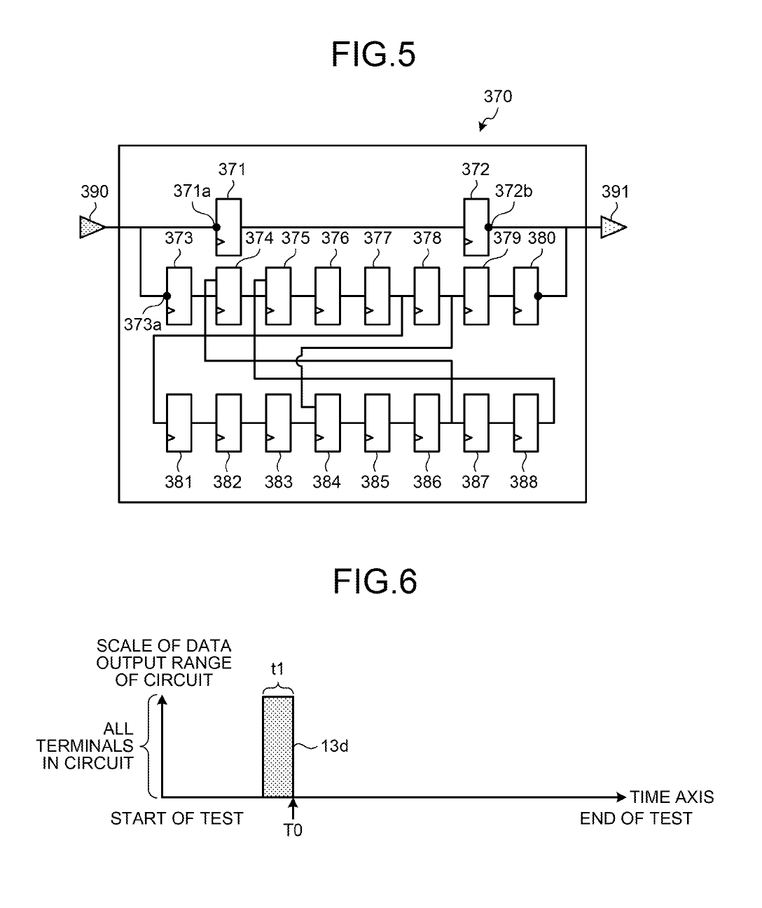

The analyzing unit 14b analyzes various kinds of information. For example, the analyzing unit 14b analyzes logic circuit information acquired by the acquiring unit 14a, and traces a circuit from an external output terminal toward an external input terminal in a network indicated by the logic circuit information. Then, with respect to each external output terminal, the analyzing unit 14b calculates the maximum number of stages of a circuit included on a route to an external input terminal. And then, on the basis of the maximum number of stages, the analyzing unit 14b calculates a duration of the minimum amount of information for error analysis needed to identify a circuit in which an error has occurred by one operation check test. Here, a concrete example of how to calculate the maximum number of stages and how to calculate the duration is explained with reference to FIGS. 4 and 5. FIGS. 4 and 5 illustrate examples of a network indicated by logic circuit information.

In the example illustrated in FIG. 4, a network 300 indicated by logic circuit information includes FFs 301 to 330 which are sequential circuits. The FFs 301 to 330 each include a data input terminal, a data output terminal, and a clock input terminal. The FFs 301 to 330 each output a signal, which has been input through the data input terminal, from the data output terminal with a delay of one test-clock period in synchronization with a test clock input to the clock input terminal.

In the example illustrated in FIG. 4, an external input terminal 350 is connected to a data input terminal 301a of the FF 301. Furthermore, in the example illustrated in FIG. 4, an external input terminal 351 is connected to a data input terminal 303a of the FF 303. Moreover, in the example illustrated in FIG. 4, an external input terminal 352 is connected to a data input terminal 311a of the FF 311 and a data input terminal 313a of the FF 313. Furthermore, in the example illustrated in FIG. 4, an external input terminal 353 is connected to a data input terminal 327a of the FF 327.

Furthermore, in the example illustrated in FIG. 4, an external output terminal 360 is connected to a data output terminal 302b of the FF 302 and a data output terminal 310b of the FF 310. Moreover, in the example illustrated in FIG. 4, an external output terminal 361 is connected to a data output terminal 312b of the FF 312 and a data output terminal 318b of the FF 318. Furthermore, in the example illustrated in FIG. 4, an external output terminal 362 is connected to a data output terminal 326b of the FF 326.

Moreover, in the example illustrated in FIG. 4, a data output terminal of the FF 301 is connected to a data input terminal of the FF 302. Furthermore, in the example illustrated in FIG. 4, the FFs 303 to 310 are serially connected. Moreover, in the example illustrated in FIG. 4, a data output terminal of the FF 311 is connected to a data input terminal of the FF 312. Furthermore, in the example illustrated in FIG. 4, the FFs 313 to 318 are serially connected. Moreover, in the example illustrated in FIG. 4, a data output terminal of the FF 314 is connected to a data input terminal of the FF 319. Furthermore, in the example illustrated in FIG. 4, the FFs 319 to 326 are serially connected. Moreover, in the example illustrated in FIG. 4, the FFs 327 to 330 are serially connected. Furthermore, in the example illustrated in FIG. 4, a data output terminal of the FF 330 is connected to a data input terminal of the FF 323.

In the example illustrated in FIG. 4, the analyzing unit 14b calculates the number of stages of FFs on respective routes from the external output terminal 360 to the external input terminals 350 and 351 corresponding to the external output terminal 360. In the example illustrated in FIG. 4, as for the route from the external output terminal 360 to the external input terminal 350 through the FFs 301 and 302, the analyzing unit 14b calculates that the number of stages of FFs is “2”. Furthermore, in the example illustrated in FIG. 4, as for the route from the external output terminal 360 to the external input terminal 351 through the FFs 303 to 310, the analyzing unit 14b calculates that the number of stages of FFs is “8”. Therefore, in the example illustrated in FIG. 4, the analyzing unit 14b calculates that the maximum number of stages of the circuit included on the routes to external input terminals corresponding to the external output terminal 360 is “8”.

Here, the FFs 301 to 330 each output information with a delay of one test-clock period; therefore, the maximum delay time of information transmission from an external input terminal to an external output terminal is “the maximum number of stages×one test-clock period”. Furthermore, on the occurrence of an error in a circuit, information indicating respective states of signals of terminals for at least “(the maximum number of stages+1)×one test-clock period” prior to the occurrence of the error is needed to identify the circuit in which the error has occurred by one operation check test. The reason for this is that when an error has been occurred in the first stage of a circuit connected to an external input terminal, and the error has been detected from a result of output of an external output terminal, a state of a signal of a terminal in the first stage of the circuit that causes the error is the following state. That is, a state of a signal of the terminal in the first stage of the circuit that causes the error is a state for “(the maximum number of stages+1)×one test-clock period” prior to the detection of the error. Therefore, in the example illustrated in FIG. 4, when an error has been detected from a result of output of the external output terminal 360, the following information is needed to identify a circuit in which the error has occurred by one operation check test. That is, information on respective states of signals of terminals for at least “(8+1)×one test-clock period” prior to the occurrence of the error is needed. Therefore, in the example illustrated in FIG. 4, the analyzing unit 14b calculates that the duration of information for error analysis indicating respective states of signals of terminals of circuits existing between the external output terminal 360 and the external input terminals 350 and 351 is “(8+1)×one test-clock period”.

Furthermore, in the example illustrated in FIG. 4, the analyzing unit 14b calculates the number of stages of FFs on a route from the external output terminal 361 to the external input terminal 352 corresponding to the external output terminal 361. In the example illustrated in FIG. 4, there are two routes from the external output terminal 361 to the external input terminal 352. In the example illustrated in FIG. 4, as for one route through the FFs 311 and 312, the analyzing unit 14b calculates that the number of stages of FFs is “2”. Furthermore, in the example illustrated in FIG. 4, as for the other route through the FFs 313 to 318, the analyzing unit 14b calculates that the number of stages of FFs is “6”. Therefore, in the example illustrated in FIG. 4, the analyzing unit 14b calculates that the maximum number of stages of the circuit included on the routes to external input terminals corresponding to the external output terminal 361 is “6”. Consequently, in the example illustrated in FIG. 4, when an error has been detected from a result of output of the external output terminal 361, the following information is needed to identify a circuit in which the error has occurred by one operation check test. That is, information on respective states of signals of terminals for at least “(6+1)×one test-clock period” prior to the occurrence of the error is needed. Therefore, in the example illustrated in FIG. 4, the analyzing unit 14b calculates that the duration of information for error analysis indicating respective states of signals of terminals of circuits existing between the external output terminal 361 and the external input terminals 352 is “(6+1)×one test-clock period”.

Moreover, in the example illustrated in FIG. 4, the analyzing unit 14b calculates the number of stages of FFs on routes from the external output terminal 362 to the external input terminals 352 and 353 corresponding to the external output terminal 362. In the example illustrated in FIG. 4, as for the route from the external output terminal 362 to the external input terminal 352 through the FFs 313, 314, and 319 to 326, the analyzing unit 14b calculates that the number of stages of FFs is “10”. Furthermore, in the example illustrated in FIG. 4, as for the route from the external output terminal 362 to the external input terminal 353 through the FFs 327 to 330 and 323 to 326, the analyzing unit 14b calculates that the number of stages of FFs is “8”. Therefore, in the example illustrated in FIG. 4, the analyzing unit 14b calculates that the maximum number of stages of the circuit included on the routes to external input terminals corresponding to the external output terminal 362 is “10”. Consequently, in the example illustrated in FIG. 4, when an error has been detected from a result of output of the external output terminal 362, the following information is needed to identify a circuit in which the error has occurred by one operation check test. That is, information on respective states of signals of terminals for at least “(10+1)×one test-clock period” prior to the occurrence of the error is needed. Therefore, in the example illustrated in FIG. 4, the analyzing unit 14b calculates that the duration of information for error analysis indicating respective states of signals of terminals of circuits existing between the external output terminal 362 and the external input terminals 352 and 353 is “(10+1)×one test-clock period”.

In the example illustrated in FIG. 5, a network 370 indicated by logic circuit information includes FFs 371 to 388 which are sequential circuits. The FFs 371 to 373, 376 to 383, and 385 to 388 each include a data input terminal, a data output terminal, and a clock input terminal. The FFs 371 to 373, 376 to 383, and 385 to 388 each output a signal, which has been input through the data input terminal, from the data output terminal with a delay of one test-clock period in synchronization with a test clock input to the clock input terminal. The FFs 374, 375, and 384 each include a first data input terminal, a second data input terminal, a data output terminal, and a clock input terminal. The FFs 374, 375, and 384 each output a signal based on signals, which have been input through the first and second data input terminals, from the data output terminal with a delay of one clock period in synchronization with a test clock input to the clock input terminal.

In the example illustrated in FIG. 5, an external input terminal 390 is connected to a data input terminal 371a of the FF 371 and a data input terminal 373a of the FF 373. Furthermore, in the example illustrated in FIG. 5, an external output terminal 391 is connected to a data output terminal 372b of the FF 372 and a data output terminal of the FF 380.

Furthermore, in the example illustrated in FIG. 5, a data output terminal of the FF 371 is connected to a data input terminal of the FF 372. Moreover, in the example illustrated in FIG. 5, a data output terminal of the FF 373 is connected to a first data input terminal of the FF 374. Furthermore, in the example illustrated in FIG. 5, a data output terminal of the FF 374 is connected to a first data input terminal of the FF 375. Moreover, in the example illustrated in FIG. 5, the FFs 375 to 380 are serially connected. Furthermore, in the example illustrated in FIG. 5, a data output terminal of the FF 377 is connected to a data input terminal of the FF 381. Moreover, in the example illustrated in FIG. 5, the FFs 381 to 383 are serially connected. Furthermore, in the example illustrated in FIG. 5, a data output terminal of the FF 383 is connected to a first data input terminal of the FF 384. Moreover, in the example illustrated in FIG. 5, the FFs 384 to 388 are serially connected. Furthermore, in the example illustrated in FIG. 5, a data output terminal of the FF 388 is connected to a second data input terminal of the FF 375. Moreover, in the example illustrated in FIG. 5, a data output terminal of the FF 386 is connected to a second data input terminal of the FF 374. Furthermore, in the example illustrated in FIG. 5, a data output terminal of the FF 378 is connected to a second data input terminal of the FF 384.

In the example illustrated in FIG. 5, the analyzing unit 14b calculates the number of stages of FFs on a route from the external output terminal 391 to the external input terminal 390 corresponding to the external output terminal 391. In the example illustrated in FIG. 5, there are six routes from the external output terminal 391 to the external input terminal 390. In the example illustrated in FIG. 5, as for the first route through the FFs 371 and 372, the analyzing unit 14b calculates that the number of stages of FFs is “2”. Furthermore, in the example illustrated in FIG. 5, as for the second route through the FFs 373 to 380, the analyzing unit 14b calculates that the number of stages of FFs is “8”. Moreover, as for the third route having a loop in part thereof, such as a route through the FFs 373 to 377, 381 to 388, and 375 to 380, the analyzing unit 14b calculates that the number of stages of FFs is “19”. Furthermore, in the example illustrated in FIG. 5, as for the fourth route having a loop in part thereof, such as a route through the FFs 373 to 378, 384 to 386, and 374 to 380, the analyzing unit 14b calculates that the number of stages of FFs is “16”. Moreover, as for the fifth route having a loop in part thereof, such as a route through the FFs 373 to 377, 381 to 386, and 374 to 380, the analyzing unit 14b calculates that the number of stages of FFs is “18”. Furthermore, in the example illustrated in FIG. 5, as for the sixth route having a loop in part thereof, such as a route through the FFs 373 to 378, 384 to 388, and 375 to 380, the analyzing unit 14b calculates that the number of stages of FFs is “17”. Therefore, in the example illustrated in FIG. 5, the analyzing unit 14b calculates that the maximum number of stages of the circuit included on the routes to an external input terminal corresponding to the external output terminal 391 is “19”. In this manner, when a loop is contained in part of a route, the analyzing unit 14b calculates the maximum number of stages by circling the entire loop. Furthermore, in the example illustrated in FIG. 5, the analyzing unit 14b calculates that the duration of information for error analysis indicating respective states of signals of terminals of circuits existing between the external output terminal 391 and the external input terminal 390 is “(19+1)×one test-clock period”.

Furthermore, the analyzing unit 14b registers the logic circuit information and circuit delay information acquired by the acquiring unit 14a in one empty record of the circuit database 13a.

Moreover, the analyzing unit 14b analyzes the test pattern acquired by the acquiring unit 14a, and obtains a name of an external input terminal that externally changes the operation, a pattern of a signal input to the external input terminal, and the timing to input the pattern to the external input terminal. Then, the analyzing unit 14b stores information including the name of the external input terminal, the signal pattern, and the timing as the test input value information 13b in the storage unit 13.

Furthermore, the analyzing unit 14b analyzes the test pattern acquired by the acquiring unit 14a, and obtains a name of an external output terminal that outputs information processed by circuits in the network subject to the operation check test and an expected value of a signal output from the external output terminal. Moreover, the analyzing unit 14b analyzes the test pattern, and obtains the timing to check whether a value of a signal output from the external output terminal is different from the expected value. Then, the analyzing unit 14b stores information including the name of the external output terminal, the expected value, and the timing as the test expected value information 13c in the storage unit 13.

The simulating unit 14c simulates the operation of a circuit. For example, the simulating unit 14c acquires logic circuit information and circuit delay information of an object of an operation check test from the circuit DB 13a. Furthermore, the simulating unit 14c acquires the test input value information 13b from the storage unit 13. Moreover, the simulating unit 14c acquires the test expected value information 13c from the storage unit 13. Then, the simulating unit 14c simulates the operation of a circuit in a network indicated by the logic circuit information with consideration of delay information of each element indicated by the circuit delay information. In this simulation, the simulating unit 14c inputs a test pattern included in the test input value information 13b to an external input terminal whose name is included in the test input value information 13b at the timing included in the test input value information 13b. Then, as a result of the simulation, the simulating unit 14c determines whether an output value of an external output terminal whose name is included in the test expected value information 13c is different from an expected value included in the test expected value information 13c at the timing included in the test expected value information 13c. Namely, the simulating unit 14c detects an error on the basis of the test expected value information 13c.

The storage control unit 14d stores the minimum amount of information used for error analysis out of pieces of information indicating respective states of signals of terminals of a circuit of which the operation has been simulated by the simulating unit 14c in the storage unit 13. Namely, the storage control unit 14d controls the storage unit 13 so that the information is stored in the storage unit 13.

For example, the storage control unit 14d stores, as temporary data 13d, information for the duration calculated by the analyzing unit 14b prior to the present time out of the pieces of information indicating respective states of signals of terminals of the simulated circuit in the storage unit 13.

In the example illustrated in FIG. 4, the storage control unit 14d stores information indicating respective states and times of signals of the data input terminals and data output terminals of the FFs 301 to 310 for the duration of “(8+1)×one test-clock period” prior to the present time in the storage unit 13. Furthermore, in the example illustrated in FIG. 4, the storage control unit 14d stores information indicating respective states and times of signals of the data input terminals and data output terminals of the FFs 311, 312, and 315 to 318 for the duration of “(6+1)×one test-clock period” prior to the present time in the storage unit 13. Moreover, in the example illustrated in FIG. 4, the storage control unit 14d stores the following information, which is information indicating respective states and times of signals of the data input terminals and data output terminals of the FFs 313, 314, and 319 to 330, in the storage unit 13. That is, the storage control unit 14d stores the information for the duration of “(10+1)×one test-clock period” prior to the present time in the storage unit 13. In the example illustrated in FIG. 4, the sum of the information indicating respective states and times of signals of the data input terminals and data output terminals of the FFs 301 to 330 is stored as the temporary data 13d in the storage unit 13.

In the example illustrated in FIG. 5, the storage control unit 14d stores information indicating respective states and times of signals of the data input terminals and data output terminals of the FFs 371 to 388 for the duration of “(19+1)×one test-clock period” prior to the present time in the storage unit 13. In the example illustrated in FIG. 5, the sum of the information indicating respective states of signals of the data input terminals and data output terminals of the FFs 371 to 388 is stored as the temporary data 13d in the storage unit 13.

Incidentally, in the examples illustrated in FIGS. 4 and 5, there is described the case where the storage control unit 14d stores information indicating respective states of signals of a data input terminal and a data output terminal in the storage unit 13. Alternatively, the storage control unit 14d can be configured to store information indicating a state of a signal of either a data input terminal or a data output terminal in the storage unit 13. Furthermore, the storage control unit 14d can store information indicating respective states and times of signals of terminals in not the entire range but a circuit range specified by an examiner or a person involved in the storage unit 13. Moreover, the storage control unit 14d can store information on only a terminal of which the signal value has been changed, for example, from 0 to 1 or 1 to 0 on the leading edge of a test clock input to a circuit, in which a state after the change, a name of the terminal, and the time are associated, in the storage unit 13.

Furthermore, the storage control unit 14d can be configured to calculate a duration depending on a delay time between a terminal and an external output terminal with respect to each terminal and store information indicating respective states of signals for the calculated duration prior to the present time in the storage unit 13.

FIG. 6 is a diagram illustrating an example of temporary data according to the embodiment. The horizontal axis in FIG. 6 indicates the time from the start of an operation check test to the end of the operation check test, and the vertical axis indicates the number of terminals that output information to be stored as the temporary data 13d in the storage unit 13. In the example illustrated in FIG. 6, the temporary data 13d is information indicating respective states of signals of all terminals in a network for a duration t1 prior to the present time T0.

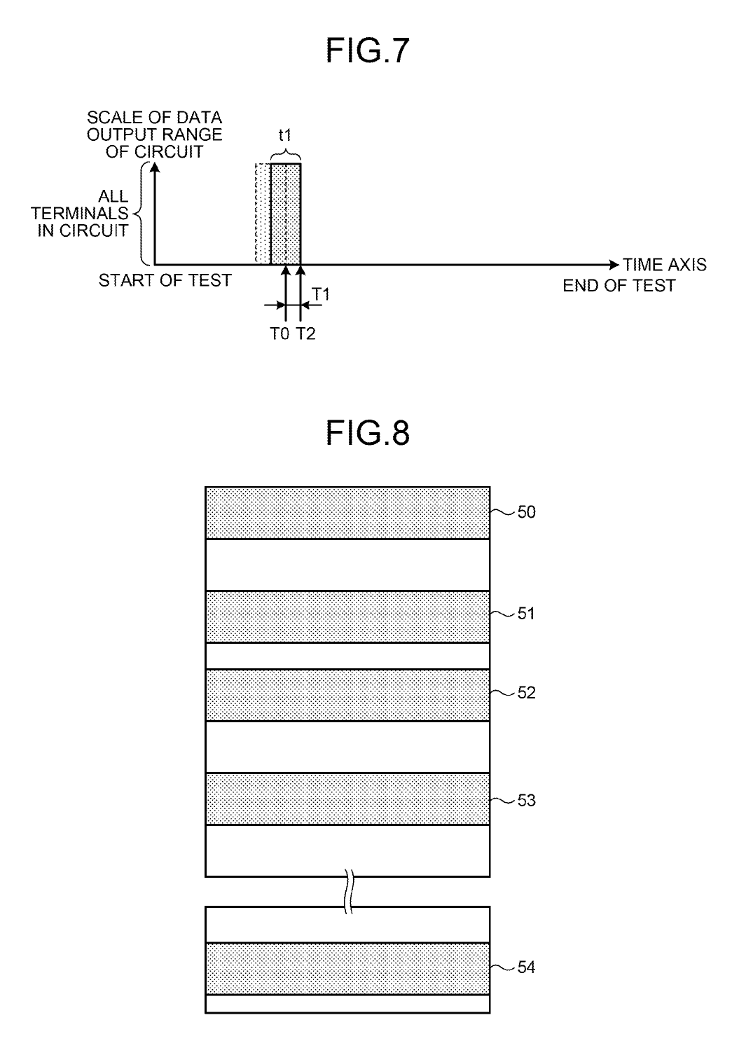

FIG. 7 is a diagram illustrating an example of temporary data after the elapse of a predetermined time since the point of time illustrated in FIG. 6. The horizontal axis in FIG. 7 indicates the time from the start of an operation check test to the end of the operation check test, and the vertical axis indicates the number of terminals that output information to be stored as the temporary data 13d in the storage unit 13. In the example illustrated in FIG. 7, the temporary data 13d is information indicating respective states of signals of all terminals in a network for the duration t1 prior to the present time T2 at which a predetermined time T1 has elapsed since the time T0 in the example illustrated in FIG. 6.

FIG. 8 is a diagram for explaining an example of a storage method of the storage control unit according to the embodiment. FIG. 8 illustrates an example of the storage method of how the storage control unit 14d stores information indicating a state of a signal of one terminal in the storage unit. In the example illustrated in FIG. 8, information for a duration of four test-clock periods is stored in the storage unit 13 by the storage control unit 14d. As illustrated in FIG. 8, first, the storage control unit 14d reserves a management area 50 for management of a storage location of information indicating a state of a signal of one terminal on the storage unit 13. Then, on each leading edge of a test clock, the storage control unit 14d controls the storage unit 13 so that information indicating a state of a signal of the object terminal is stored in a storage area in which no information has been stored out of storage areas 51 to 54 on the storage unit 13. When all of the storage areas 51 to 54 have stored therein information, on each leading edge of a test clock, the storage control unit 14d deletes the oldest information in those stored in the storage areas 51 to 54 on the storage unit 13. Incidentally, the storage control unit 14d can search for a storage area in which the oldest information has been stored on the basis of memory contents stored in the management area 50. Then, on each leading edge of a test clock, the storage control unit 14d controls the storage unit 13 so that information indicating a state of a signal of the object terminal is stored in the storage area from which the oldest information was deleted. And, on each leading edge of a test clock, the storage control unit 14d controls the storage unit 13 so that an address of a storage area in which information has been stored and the time at which the information has been stored in the management area 50. The storage control unit 14d performs such a process until completion of the operation check test.

Furthermore, when a duration of ten test-clock periods is set in the temporary data constraints, the storage control unit 14d stores information indicating a state of a signal sequentially in a free area of the memory for the first ten periods. Then, from the eleventh period onward, the storage control unit 14d searches for a storage area storing therein the oldest information at the time on the basis of information stored in the management area 50, and deletes the information stored in the found storage area, and then stores new information for one period in the storage area. Moreover, when a duration of a specific time, such as 100 μs, is set in the temporary data constraints, the storage control unit 14d just reserves as many storage areas as the number obtained by dividing the specific time by the length of one test-clock period, and stores information in the same manner as the above-described process.

The output unit 14e outputs, when an error has been detected, information indicating a state of a signal of a terminal related to the error from the temporary data 13d to the waveform file 13e. For example, the output unit 14e extracts information indicating a state of a signal of a terminal existing between an external output terminal in which an error has been detected and an external input terminal corresponding to this external input terminal from the temporary data 13d, and outputs the extracted information to the waveform file 13e. To explain with a concrete example, the output unit 14e outputs a set of respective pieces of information stored in the storage areas of the storage unit 13 to the waveform file 13e.

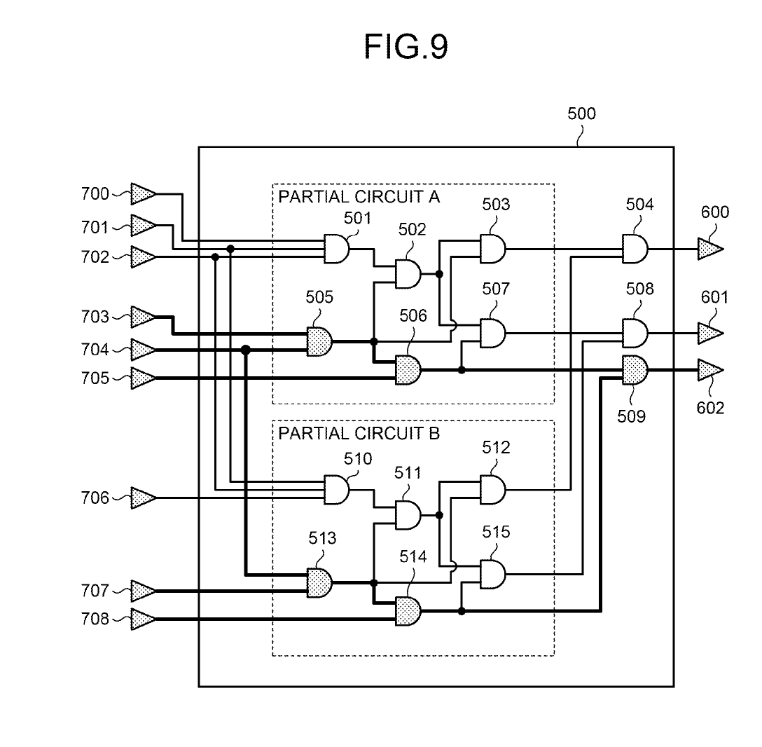

FIG. 9 is a diagram for explaining a terminal whose information is to be output to the waveform file. In an example illustrated in FIG. 9, a network 500 includes delay circuits 501 to 515. The delay circuits 501 to 515 each include multiple input terminals and one output terminal. In the example illustrated in FIG. 9, the delay circuits 501 to 504 exist between an external output terminal 600 and an external input terminal 700. Furthermore, in the example illustrated in FIG. 9, the delay circuits 501 to 504 exist between the external output terminal 600 and an external input terminal 701. Moreover, in the example illustrated in FIG. 9, the delay circuits 501 to 504 exist between the external output terminal 600 and an external input terminal 702. Furthermore, in the example illustrated in FIG. 9, the delay circuits 502 to 505 exist between the external output terminal 600 and an external input terminal 703. Moreover, in the example illustrated in FIG. 9, the delay circuits 502 to 505 exist between the external output terminal 600 and an external input terminal 704.

Furthermore, in the example illustrated in FIG. 9, the delay circuits 504 and 510 to 512 exist between the external output terminal 600 and an external input terminal 706. Moreover, in the example illustrated in FIG. 9, the delay circuits 504 and 511 to 513 exist between the external output terminal 600 and an external input terminal 707.

Furthermore, in the example illustrated in FIG. 9, the delay circuits 501, 502, 507 and 508 exist between an external output terminal 601 and the external input terminal 700. Moreover, in the example illustrated in FIG. 9, the delay circuits 501, 502, 507, 508, 510, 511, and 515 exist between the external output terminal 601 and the external input terminal 701. Furthermore, in the example illustrated in FIG. 9, the delay circuits 501, 502, 507, 508, 510, 511, and 515 exist between the external output terminal 601 and the external input terminal 702. Moreover, in the example illustrated in FIG. 9, the delay circuits 505 to 508 exist between the external output terminal 601 and the external input terminal 703.

Furthermore, in the example illustrated in FIG. 9, the delay circuits 505 to 508 and 513 to 515 exist between the external output terminal 601 and the external input terminal 704. Moreover, in the example illustrated in FIG. 9, the delay circuits 506 to 508 exist between the external output terminal 601 and an external input terminal 705. Furthermore, in the example illustrated in FIG. 9, the delay circuits 508, 510, 511, and 515 exist between the external output terminal 601 and the external input terminal 706. Moreover, in the example illustrated in FIG. 9, the delay circuits 508 and 513 to 515 exist between the external output terminal 601 and the external input terminal 707. Furthermore, in the example illustrated in FIG. 9, the delay circuits 508, 514, and 515 exist between the external output terminal 601 and an external input terminal 708.

Moreover, in the example illustrated in FIG. 9, the delay circuits 505, 506, and 509 exist between an external output terminal 602 and the external input terminal 703. Furthermore, in the example illustrated in FIG. 9, the delay circuits 505, 506, 509, 513, and 514 exist between the external output terminal 602 and the external input terminal 704. Moreover, in the example illustrated in FIG. 9, the delay circuits 506 and 509 exist between the external output terminal 602 and the external input terminal 705. Furthermore, in the example illustrated in FIG. 9, the delay circuits 509, 513, and 514 exist between the external output terminal 602 and the external input terminal 707. Moreover, in the example illustrated in FIG. 9, the delay circuits 509 and 514 exist between the external output terminal 602 and the external input terminal 708.

In the example illustrated in FIG. 9, when an error has been detected in the external output terminal 602, the output unit 14e performs the following process. That is, the output unit 14e extracts information indicating respective states of signals of the input terminals and output terminals of the delay circuits 505, 506, 509, 513, and 514 existing between the external output terminal 602 and the external input terminals 703 to 705, 707, and 708 from the temporary data 13d. Then, the output unit 14e outputs the extracted information to the waveform file 13e. Consequently, an examiner just analyzes contents of the waveform file 13e which is the minimum amount of information used for error analysis, so that the error analysis can be easily performed by one operation check test.

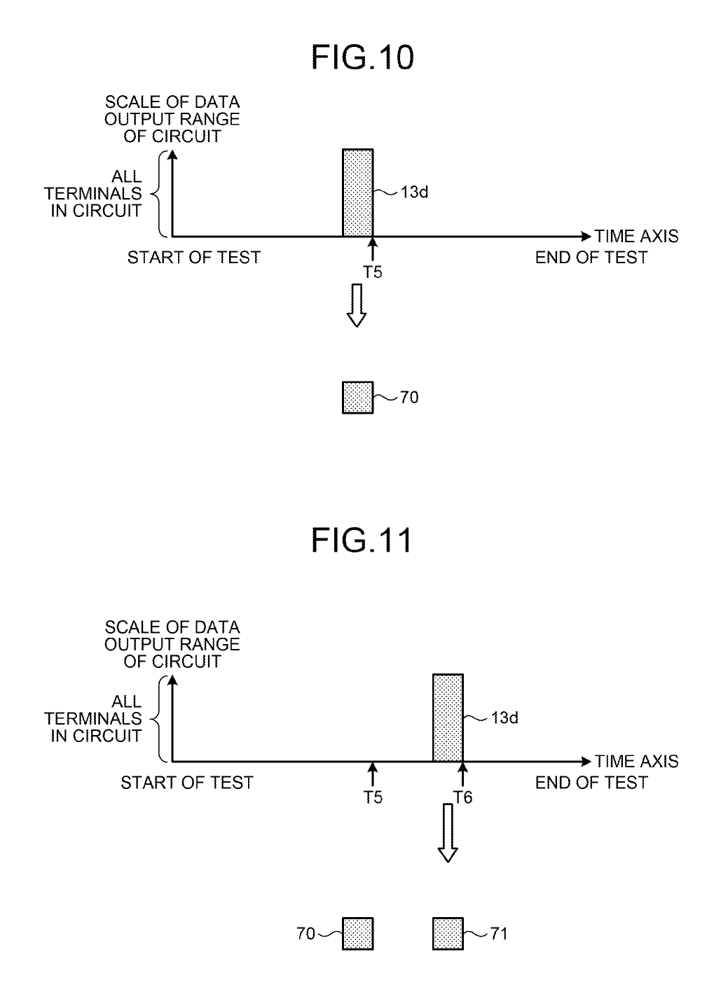

FIGS. 10 and 11 are diagrams for explaining a process of extracting information to be output to the waveform file from temporary data. The horizontal axis in FIG. 10 indicates the time from the start of an operation check test to the end of the operation check test, and the vertical axis indicates the number of terminals whose signal information is output to the waveform file 13e. In an example illustrated in FIG. 10, when an error has been detected at a time T5, the output unit 14e extracts information 70 related to the error from the temporary data 13d, and outputs the information 70 to the waveform file 13e.

The horizontal axis in FIG. 11 indicates the time from the start of an operation check test to the end of the operation check test, and the vertical axis indicates the number of terminals whose signal information is output to the waveform file 13e. In an example illustrated in FIG. 11, when an error has been detected at the time T5 as in the example illustrated in FIG. 10, the output unit 14e extracts the information 70 related to the error from the temporary data 13d, and outputs the information 70 to the waveform file 13e. Furthermore, in the example illustrated in FIG. 11, when an error has been detected at a time T6, the output unit 14e extracts information 71 related to the error from the temporary data 13d, and outputs the information 71 to the waveform file 13e.

In this manner, each time an error has been detected, the output unit 14e extracts information related to the error from the temporary data 13d, and outputs the extracted information to the waveform file 13e.

Furthermore, the output unit 14e generates the simulation log 13f containing a result of simulation, such as the time of an error which occurred in the simulation, and stores the simulation log 13f in the storage unit 13.

Flow of Process

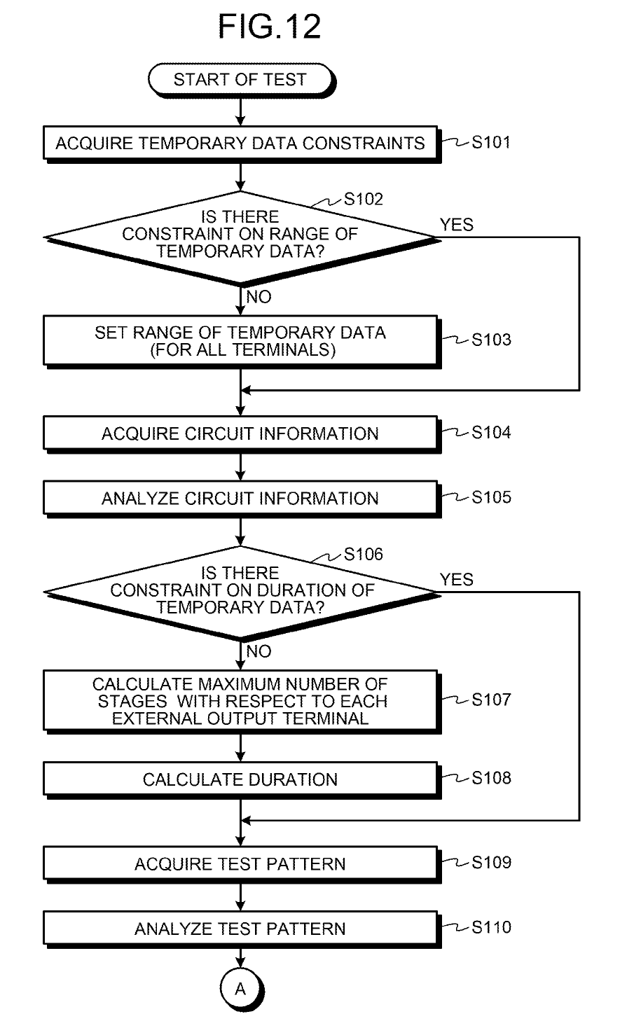

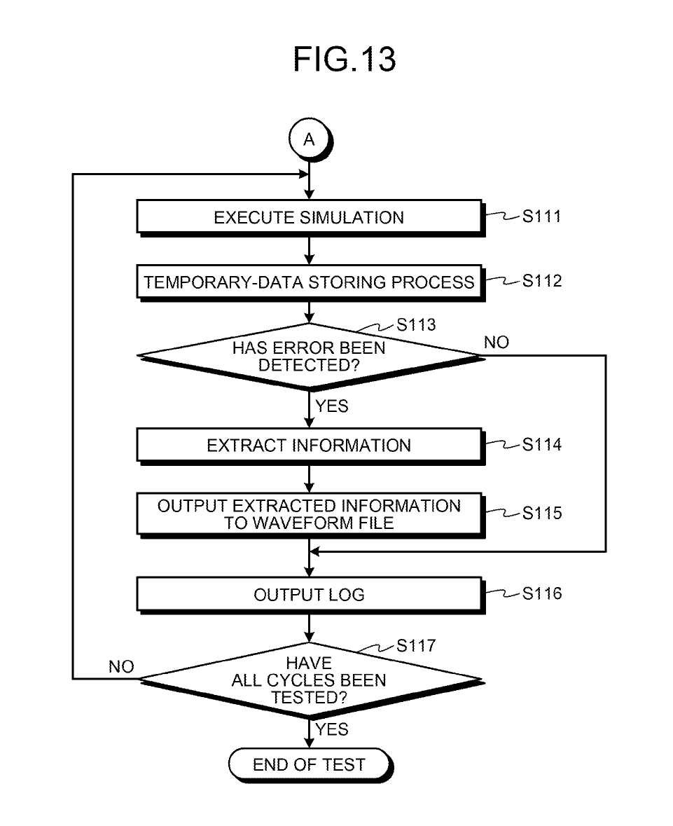

Subsequently, the flow of a process performed by the circuit design support apparatus 10 according to the present embodiment is explained. FIGS. 12 and 13 are flowcharts illustrating a procedure of a circuit design support process according to the embodiment. This circuit design support process is executed when an instruction to execute the circuit design support process has been input from the input unit 11 to the control unit 14.

As illustrated in FIG. 12, the acquiring unit 14a acquires temporary data constraints (Step S101).

The analyzing unit 14b determines whether the temporary data constraints contain information defining a circuit range (Step S102).

When the temporary data constraints do not contain information defining a circuit range (NO at Step S102), the analyzing unit 14b sets the entire range of a network subject to storage of information on a state of a signal of a terminal as a circuit range (Step S103). On the other hand, when the temporary data constraints contain information defining a circuit range (YES at Step S102), the process moves onto Step S104.

The acquiring unit 14a acquires logic circuit information and circuit delay information (Step S104). The analyzing unit 14b registers the logic circuit information and the circuit delay information in one empty record of the circuit DB 13a (Step S105).

The analyzing unit 14b determines whether the temporary data constraints contain information defining a duration (Step S106). When the temporary data constraints do not contain information defining a duration (NO at Step S106), the analyzing unit 14b calculates the maximum number of stages with respect to each external output terminal (Step S107). The analyzing unit 14b calculates a duration with respect to each external output terminal (Step S108). When the temporary data constraints contain information defining a duration (YES at Step S106), the process moves onto Step S109.

The acquiring unit 14a acquires a test pattern (Step S109). The analyzing unit 14b analyzes the test pattern, and stores the test input value information 13b and the test expected value information 13c in the storage unit 13 (Step S110).

The simulating unit 14c simulates the operation of a circuit in the network indicated by the logic circuit information on the basis of the test input value information 13b, the test expected value information 13c, the logic circuit information, and the circuit delay information (Step S111).

The storage control unit 14d performs a temporary-data storing process to be described later, which is a process of storing the temporary data 13d in the storage unit 13 (Step S112).

The simulating unit 14c determines whether an error has been detected (Step S113). When an error has been detected (YES at Step S113), the output unit 14e extracts information related to the error from the temporary data 13d (Step S114). The output unit 14e outputs the extracted information to the waveform file 13e (Step S115). The output unit 14e generates the simulation log 13f, and stores the simulation log 13f in the storage unit 13 (Step S116). On the other hand, when no error has been detected (NO at Step S113), the process moves onto Step S116. The simulating unit 14c determines whether an operation check test has been performed in all cycles (Step S117); when an operation check test has not been performed in all cycles (NO at Step S117), the process returns to Step S111. On the other hand, when an operation check test has been performed in all cycles (YES at Step S117), the process is ended.

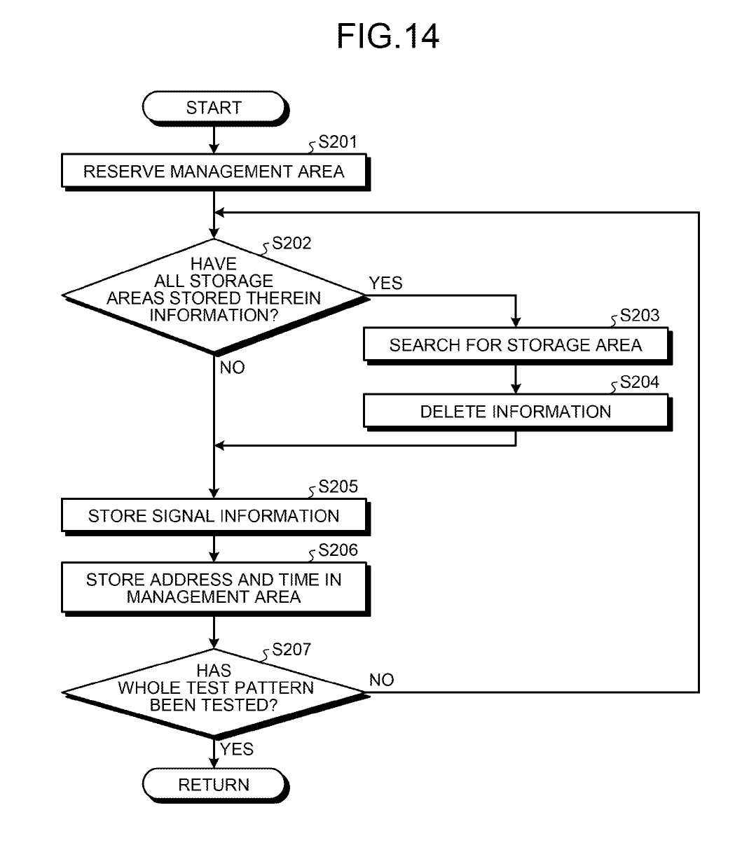

Subsequently, the flow of the temporary-data storing process at Step S112 is explained. FIG. 14 is a flowchart illustrating a procedure of the temporary-data storing process according to the embodiment.

As illustrated in FIG. 14, the storage control unit 14d reserves the management area 50 on the storage unit 13 with respect to each terminal (Step S201). On each leading edge of a test clock, the storage control unit 14d determines, with respect to each terminal, whether all storage areas on the storage unit 13 have stored therein information (Step S202). When all the storage areas have stored therein information (YES at Step S202), the storage control unit 14d searches for a storage area in which the oldest information has been stored on the basis of the management area 50 for each terminal (Step S203).

The storage control unit 14d deletes the information stored in the found storage area (Step S204). The storage control unit 14d stores information indicating a state of a signal of a corresponding terminal in the found storage area (Step S205). The storage control unit 14d stores an address of the storage area in which the information has been stored and the time at which the information has been stored in the management area 50 (Step S206). The storage control unit 14d determines whether simulation has been performed on the whole test pattern (Step S207); when simulation has not been performed on the whole test pattern (NO at Step S207), the process returns to Step S202. On the other hand, when simulation has been performed on the whole test pattern (YES at Step S207), the process is ended.

Effects of Embodiment

As described above, the circuit design support apparatus 10 according to the present embodiment simulates the operation of each circuit in a predetermined network on the basis of circuit information indicating the network. The circuit design support apparatus 10 according to the present embodiment controls the storage unit 13 so that information indicating a state of a signal of a terminal of the circuit in the simulated network for a period of time depending on a delay time of the circuit is stored in the storage unit 13. When the circuit design support apparatus 10 according to the present embodiment has detected an error in a predetermined terminal, the circuit design support apparatus 10 outputs information on a state of a signal of the terminal for the period of time which has been stored in the storage unit 13 to the waveform file 13e for error analysis. In this manner, the circuit design support apparatus 10 according to the present embodiment outputs the minimum amount of information capable of identifying an element in which an error has been occurred by one operation check test to the waveform file 13e. Therefore, the circuit design support apparatus 10 according to the present embodiment can suppress an amount of information output to the waveform file while curbing the number of operation check tests.

Furthermore, the circuit design support apparatus 10 according to the present embodiment controls the storage unit 13 so that information for a delay time depending on the number of sequential circuits existing on the longest route from an external input terminal corresponding to each terminal to an external output terminal of the circuit is stored in the storage unit 13 with respect to each terminal. Therefore, the circuit design support apparatus 10 according to the present embodiment can store information for a delay time appropriate to error analysis in the storage unit 13 with respect to each terminal.

Moreover, when the circuit design support apparatus 10 according to the present embodiment has detected an error in an external input terminal which is an example of the predetermined terminal, the circuit design support apparatus 10 outputs information on respective states of signals of terminals existing between the predetermined terminal and an external input terminal corresponding to the predetermined terminal to the waveform file 13e. Therefore, the circuit design support apparatus 10 according to the present embodiment selectively outputs information related to the error out of pieces of information included in the temporary data 13d to the waveform file 13e. Consequently, the circuit design support apparatus 10 according to the present embodiment can output information enabling an examiner to perform error analysis more easily by one operation check test to the waveform file 13e.

The embodiment of the apparatus according to the present invention is explained above; however, besides the embodiment described above, the present invention can be embodied in various different forms. Other embodiments included in the present invention will be explained below.

Duration

In the above-described embodiment, there is provided an example where a duration depends on a delay time of a circuit; the apparatus according to the present invention is not limited to this. For example, the apparatus according to the present invention can apply a duration depending on a difference in timing to output information between each terminal and a terminal to which information for detection of an error is output. Furthermore, the duration is not limited to that explained in the above-described embodiment. For example, when the probability of an error in the first stage of a circuit is known to be lower than an average incidence rate of error, the apparatus according to the present invention can apply a shorter duration than that explained in the above-described embodiment by a predetermined test-clock period, such as one test-clock period. In this case, an amount of information output to the waveform file 13e is smaller, and the apparatus according to the present invention can output information enabling a user to perform error analysis more easily to the waveform file 13e.

Range of Application

In the above-described embodiment, there is provided an example where a delay occurs in a circuit in a network; the apparatus according to the present invention is not limited to this. For example, the apparatus according to the present invention can also be applied to a circuit in which no delay occurs.

Furthermore, out of the processes described in the embodiment, all or part of a process described as the automatically-performed one can be manually performed.

Likewise, out of the processes described in the embodiment, all or part of a process described as the manually-performed one can be automatically performed by a publicly-known method. For example, at Steps S101, S104, and S109 in FIG. 12, temporary data constraints, logic circuit information and circuit delay information, and a test pattern can be input to the control unit 14 by an examiner operating the input unit 11.

Moreover, processes at respective steps described in the embodiment can be arbitrarily subdivided or combined depending on various loads and use conditions, etc. Furthermore, some steps can be omitted. For example, Step S101 of acquiring temporary data constraints can be omitted; in this case, Steps S102 and S106 can also be omitted.

Furthermore, components of each apparatus illustrated in the drawings are functionally conceptual ones, and do not always have to be physically configured as illustrated in the drawings. Namely, the specific forms of division and integration of components of each apparatus are not limited to those illustrated in the drawings, and all or some of the components can be configured to be functionally or physically divided or integrated in arbitrary units depending on respective loads and use conditions, etc. For example, the simulating unit 14c and the storage control unit 14d illustrated in FIG. 1 can be integrated into one unit. Furthermore, the storage control unit 14d and the output unit 14e can be integrated into one unit.

Circuit Design Support Program

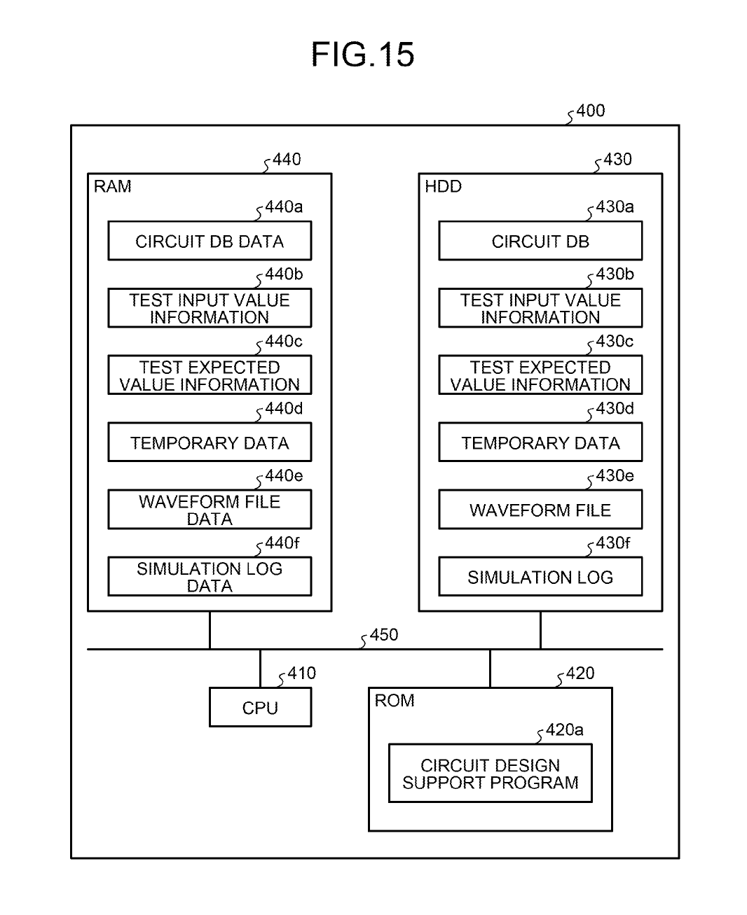

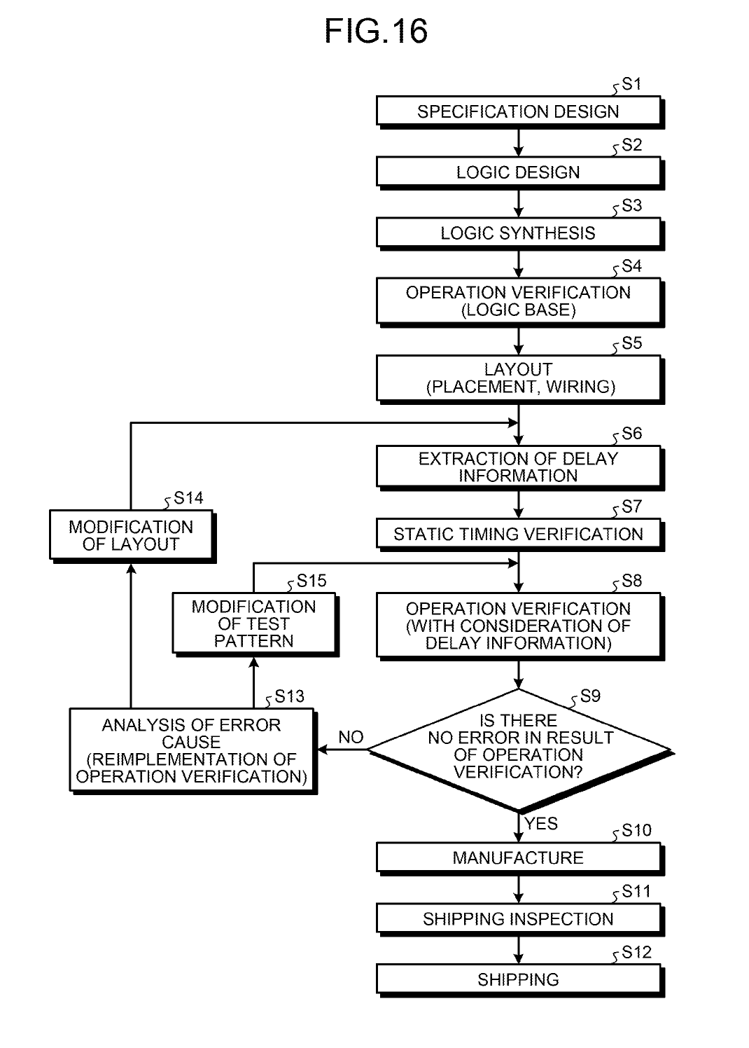

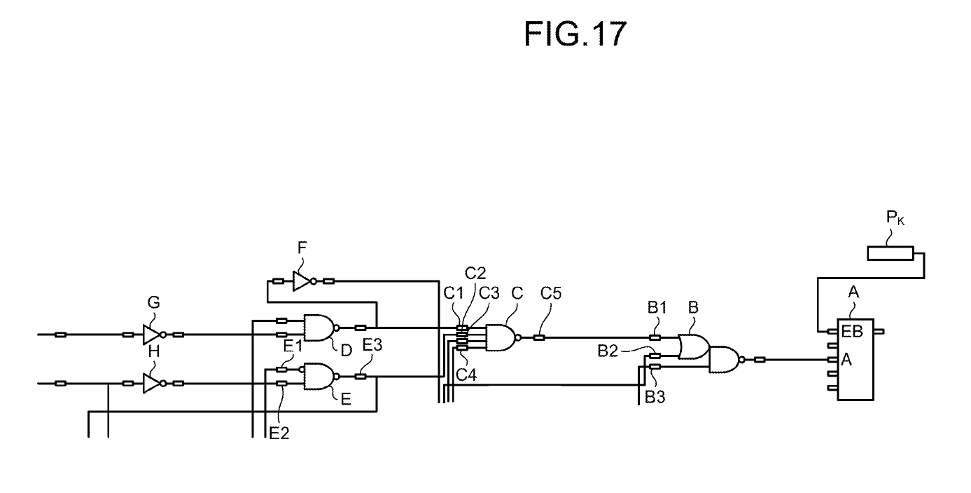

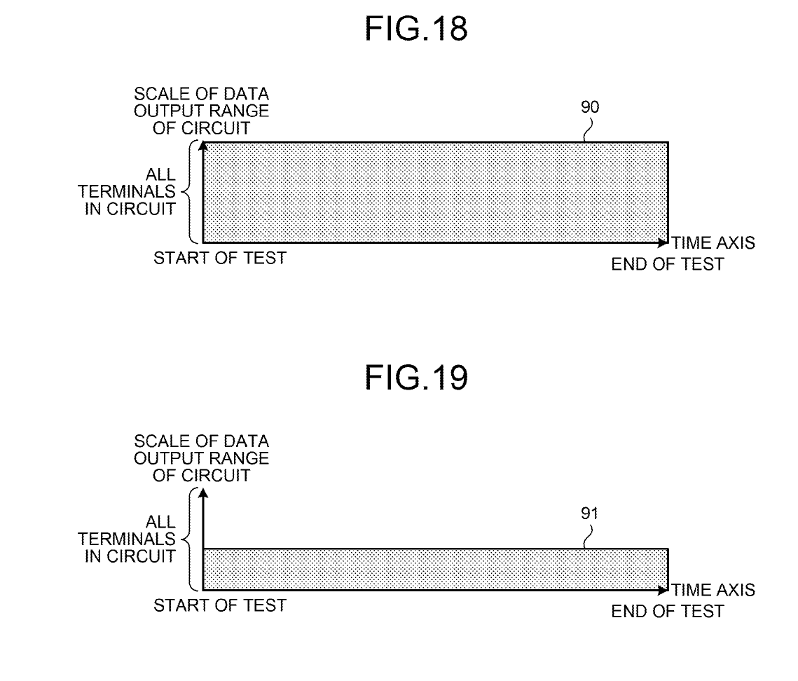

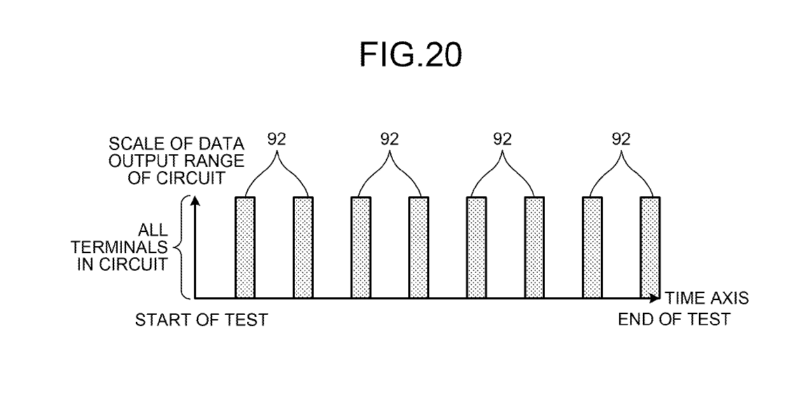

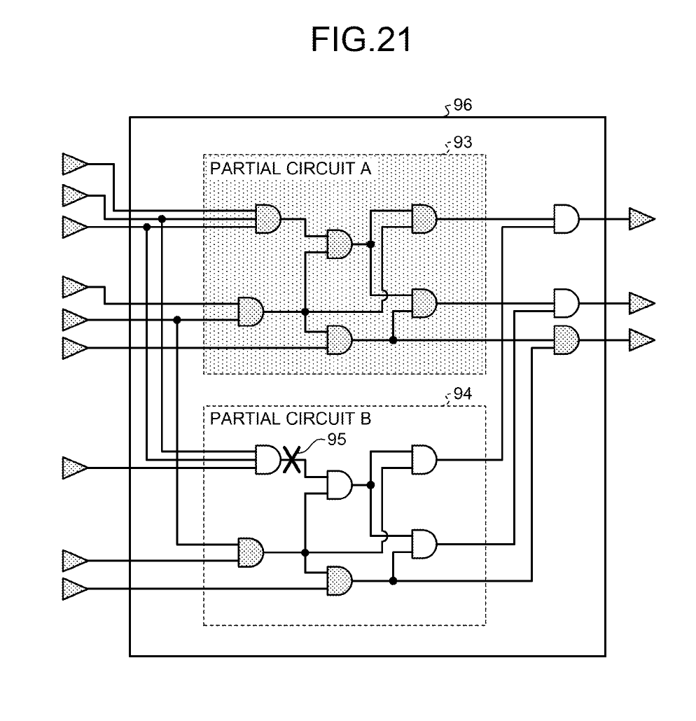

Furthermore, the various processes performed by a moving-object identifying device described in the above embodiment can be realized by causing a computer system, such as a personal computer or a workstation, to execute a program prepared in advance. An example of a computer that executes a circuit design support program having the same functions as the circuit design support apparatus described in the above embodiment is explained below with reference to FIG. 15. FIG. 15 is a diagram illustrating the computer that executes the circuit design support program.

As illustrated in FIG. 15, a computer 400 according to a embodiment includes a central processing unit (CPU) 410, a read-only memory (ROM) 420, a hard disk drive (HDD) 430, and a random access memory (RAM) 440. These units 400 to 440 are connected via a bus 450.

The circuit design support program fulfilling the same functions as the acquiring unit 14a, the analyzing unit 14b, the simulating unit 14c, the storage control unit 14d, and the output unit 14e illustrated in the above-described embodiment has been stored in the ROM 420 in advance. Namely, a circuit design support program 420a has been stored in the ROM 420 as illustrated in FIG. 15. Incidentally, the program 420a can be arbitrarily separated.

The CPU 410 reads out the program 420a from the ROM 420, and executes the read program 420a.

The HDD 430 is provided with a circuit DB 430a, test input value information 430b, test expected value information 430c, temporary data 430d, a waveform file 430e, and a simulation log 430f. The circuit DB 430a, the test input value information 430b, and the test expected value information 430c correspond to the circuit DB 13a, the test input value information 13b, and the test expected value information 13c illustrated in FIG. 1, respectively. Furthermore, the temporary data 430d, the waveform file 430e, and the simulation log 430f correspond to the temporary data 13d, the waveform file 13e, and the simulation log 13f illustrated in FIG. 1, respectively.

The CPU 410 reads out the circuit DB 430a, the test input value information 430b, the test expected value information 430c, the temporary data 430d, the waveform file 430e, and the simulation log 430f, and stores the read data in the RAM 440. The CPU 410 executes the program 420a by using circuit DB data 440a, test input value information 440b, test expected value information 440c, temporary data 440d, waveform file data 440e, and simulation log data 440f which have been stored in the RAM 440. Incidentally, all of the data stored in the RAM 440 do not always have to be stored in the RAM 440, and it is only necessary to store data used for the process in the RAM 440.

Incidentally, the above-described circuit design support program does not always have to have been stored in the HDD 430 from the beginning.

For example, the program is stored in a “portable physical medium”, such as a flexible disk (FD), a CD-ROM, a DVD, a magnet-optical disk, or an IC card, to be inserted into the computer 400. Then, the computer 400 can read out the program from the portable physical medium and execute the read program.

Furthermore, the program is stored in “another computer (or a server)” connected to the computer 400 via a public line, the Internet, a LAN, or a WAN, etc. Then, the computer 400 can read out the program from another computer or the server and execute the read program.

According to one aspect of a circuit design support apparatus discussed in the present application, it is possible to suppress an amount of information output to a waveform file while curbing the number of operation check tests.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A circuit design support apparatus comprising:
a simulating unit that simulates the operation of each circuit in a predetermined network on the basis of circuit information indicating the network, and generates simulated waveform information;
a control unit that performs control so that simulated waveform information, which is information indicating a state of a signal of a terminal of each circuit in the network simulated by the simulating unit and is information for a period of time depending on the number of stages of sequential circuits in the circuit, is stored in a storage unit; and
an output unit that outputs, when an error has been detected in a predetermined terminal, the simulated waveform information for the period of time stored in the storage unit to a waveform file for error analysis.

2. The circuit design support apparatus according to claim 1, wherein
the control unit performs control so that simulated waveform information for a period of time depending on the number of stages of sequential circuits, which is a period from when predetermined information has been input to external input terminal of the circuit till when the predetermined information has been processed in the circuit and output from an external output terminal of the circuit, is stored in the storage unit.

3. The circuit design support apparatus according to claim 1, wherein
the control unit performs control so that with respect to each terminal, simulated waveform information for a period of time depending on the number of stages of sequential circuits existing on the longest route between an external input terminal corresponding to the terminal and an external output terminal of the circuit is stored in the storage unit.

4. The circuit design support apparatus according to claim 1, wherein
when an error has been detected in a predetermined terminal, the output unit outputs simulated waveform information for a period of time depending on the number of terminals existing between the predetermined terminal and an external input terminal corresponding to the predetermined terminal to the waveform file.

5. A computer-readable recording medium having stored therein a circuit design support program causing a computer to execute a process comprising:
simulating the operation of each circuit in a predetermined network on the basis of circuit information indicating the network and generating simulated waveform information;
performing control so that simulated waveform information, which is information indicating a state of a signal of a terminal of each circuit in the simulated network and is information for a period of time depending on the number of stages of sequential circuits in the circuit, is stored in a storage unit; and
outputting, when an error has been detected in a predetermined terminal, the simulated waveform information for the period of time stored in the storage unit to a waveform file for error analysis.

6. A circuit design support method causing a computer to execute a process comprising:
simulating the operation of each circuit in a predetermined network on the basis of circuit information indicating the network and generating simulated waveform information, using a processor;
performing control so that simulated waveform information, which is information indicating a state of a signal of a terminal of each circuit in the simulated network and is information for a period of time depending on the number of stages of sequential circuits in the circuit, is stored in a storage unit, using the processor; and
outputting, when an error has been detected in a predetermined terminal, the simulated waveform information for the period of time stored in the storage unit to a waveform file for error analysis, using the processor.
